(19) United States
(12) Patent Application Publication
(10) Pub. No.: US 2006/0235653 A1
(43) Pub. Date: Oct. 19, 2006

(54) Analysis model producing system

(76) Inventors: Makoto Onodera, Mito (JP); Ichiro Kataoka, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/405,466

(22) Filed: Apr. 18, 2006

(30) Foreign Application Priority Data
Apr. 18, 2005 (JP) 2005-119211

(51) Int. Cl. G06F 15/00

(52) U.S. Cl. 702/183

(57) ABSTRACT

An analysis model producing system, having an analysis model producing means therein, for newly producing an analysis model with using an existing analysis model therein, the analysis model producing means comprising: a geometric characteristic acknowledging portion 103 for acknowledging a geometric characteristic from an outer surface element of the existing analysis model; a geometric restriction editor portion 104 for setting a geometric restriction upon the geometric characteristic acknowledged within said geometric characteristic acknowledging portion; a geometric value calculator portion 105 for calculating a geometric value of the geometric characteristic satisfying the geometric restriction set up within said geometric restriction editor portion; and an analysis model deform portion 106 for moving respective joints on said existing analysis model, so that they are coincident with the geometric characteristic, by the geometric value obtained within said geometric value calculator portion, whereby enabling to deform the existing analysis model while maintaining the geometric characteristics thereof.

### BACKGROUND OF THE INVENTION

The present invention relates to a CAE (Computer Aided Engineering) for numerically simulating physical phenomenon of a target, through numeric analysis with using a computer, and in particular, it relates to production of an analysis model in the CAE.

CAE is applied into processes for developing a product, in order to reduce the development cost and to shorten the period for designing and/or development. In the CAE, an analysis model is produced from configuration data or the like, which is produced within a CAD (Computer Aided Design) system, and upon that model is made strength analysis, heat analysis or vibration analysis through an analysis method, such as, a finite-element method, or a boundary element method, etc. Upon production of the analysis model in such the CAE, firstly mesh data must be produced from the configuration data, and there is also necessity of operations of setting up or determining parameters and/or boundary conditions for each mesh in that mesh data; therefore a large amount of operation is needed for production of the analysis model.

For such the reason, there is already proposed a technology for lightening or reducing a load relating to production of the analysis model. For example, within the technology disclosed in the following Patent Document 1, a CAD function and a CAE function are unified into one (1) system, so as to reduce the load of producing the analysis model.

Also, within the technology disclosed in the following Patent Document 2, a desired analysis model can be produced with using the existing analysis model. Thus, upon the existing analysis model are determined a plural number of reference points corresponding thereto, and then mesh model deforming or modifying is made on the existing analysis model accompanying with shifting of the reference points, upon basis of the corresponding relationship between those reference points and also the mesh model (i.e., mesh data), which is contained in the existing analysis model; thereby enabling to produce the analysis model of a target. This technology enables to make production of the mesh data and/or setting up of the boundary conditions unnecessary, in particular, in case where the existing analysis model can be applied onto a desired analysis model, and therefore reduces the load, greatly, in relation to the production of analysis model.

Patent Document 1: Japanese Patent Laying-Open No. Hei 03-70083 (1991); and

Patent Document 2: Japanese Patent Laying-Open No. 2003-108609 (2003).

As was mentioned above, the CAE has a drawback that the load of operations should be reduced, in particular, in relation to the analysis model. For this drawback is highly effective the technology disclosed in the Patent Document 2, which enables to produce the desired analysis model with using the existing analysis model. Thus, the technology of the Patent Document 2, enabling to produce the desired analysis model with using the existing analysis model, makes the production of the mesh data and the setting up of the boundary conditions unnecessary, and thereby enabling to reduce the load of operation in relation to the production of the analysis model, greatly.

However, with this technology of the Patent Document 2, since it produces the desired analysis model, deforming or modifying the existing analysis model through the shifting or movement of the reference points, therefore, there is still remained a problem that it is difficult to make setup of the reference points so that the desired analysis model can be obtained corresponding to various kinds of deforming parameters. Namely, there is still a problem that an undesirable analysis model may be produced when conducting the deforming upon the existing analysis model, such as; a circular hole is modified into an ellipse hole, for example. This technology also has another problem that it cannot be applied into a case where it is necessary to add great configuration deformation upon the existing analysis model, such as, add or delete a rib and/or a hole when producing the desired analysis model from the existing analysis model, for example.

### BRIEF SUMMARY OF THE INVENTION

According to the present invention, being accomplished upon such the situations mentioned above as a background thereof, a first object thereof is to provide an analysis model producing system, which enables to deform the existing analysis model while keeping geometric characteristics thereof, when producing a desired analysis model with using an existing analysis model. Also, a second object of the present invention is to provide an analysis model producing system, which also enables great deformation of the existing analysis model, i.e., adding or deleting a characteristic configuration, such as, a rib and/or a hole, etc., upon the desired analysis model to be produced from the existing analysis model through deforming thereof.

According to the present invention, for accomplishing the first object mentioned above, there is provided an analysis model producing system having an analysis model producing means therein, for newly producing an analysis model with using an existing analysis model therein, said analysis model producing means comprising: a geometric characteristic acknowledging portion for acknowledging a geometric characteristic from an outer surface element of the existing analysis model; a geometric restriction editor portion for setting a geometric restriction upon the geometric characteristic acknowledged within said geometric characteristic acknowledging portion; a geometric value calculator portion for calculating a geometric value of the geometric characteristic satisfying the geometric restriction set up within said geometric restriction editor portion; and an analysis model deforming portion for moving respective joints on said existing analysis model, so that they are coincident with the geometric characteristic, by the geometric value obtained within said geometric value calculator portion.

Also, according to the present invention, within the analysis model producing system described in the above, said analysis model producing means further comprises: a characteristic configuration acknowledging portion for acknowledging a characteristic configuration from the geometric characteristic acknowledged by said geometric characteristic acknowledging portion, an adding/deleting configuration appointment portion for designating the characteristic configuration to be deleted or to be added newly, with respect to the characteristic configuration acknowledged by said characteristic configuration acknowledging portion, and a mesh set calculator portion for conducting mesh calculation on the characteristic configuration being a target of deletion or addition, which is designated within said adding/deleting configuration appointment portion, and said existing analysis model.

Further, according to the present invention, within the analysis model producing system described in the above, said analysis model producing means further comprises: a geometric characteristic emphasizing display portion for displaying the geometric characteristic within the existing analysis model, emphasizing by a unit of the geometric characteristic and/or a unit of kind of the geometric characteristic, when displaying said existing analysis model, and a geometric characteristic modify portion for revising an area and a kind of said geometric characteristic, in an interactive manner.

Also, according to the present invention, within the analysis model producing system described in the above, said analysis model producing means further comprises: a characteristic configuration emphasizing display portion for displaying the characteristic configuration within the existing analysis model, emphasizing by a unit of the characteristic configuration and/or a unit of kind of the geometric characteristic configuration, when displaying said existing analysis model, and a characteristic configuration modify portion for revising said characteristic configuration and a kind thereof, in an interactive manner.

Further, according to the present invention, for accomplishing the second object mentioned above, there is provided an analysis model producing system having an analysis model producing means therein, for newly producing an analysis model with using an existing analysis model therein, comprising: a geometric characteristic acknowledging portion for acknowledging a geometric characteristic from an outer surface element of the existing analysis model; a characteristic configuration acknowledging portion for acknowledging a characteristic configuration from the geometric characteristic acknowledged by said geometric characteristic acknowledging portion; an adding/deleting configuration appointment portion for designating the characteristic configuration to be deleted or to be added newly, with respect to the characteristic configuration acknowledged by said characteristic configuration acknowledging portion; and a mesh set calculator portion for conducting mesh calculation on the characteristic configuration being a target of deletion or addition, which is designated within said adding/deleting configuration appointment portion, and said existing analysis model.

Thus, according to the present invention, the geometric characteristic thereof is acknowledged on the existing analysis model, and deformation is made on the existing analysis model upon basis of the geometric restriction, which is set up for the geometric characteristic acknowledged; thereby enabling to produce a new analysis model. For this reason, according to the present invention, it is possible to obtain an analysis mode at desire through deforming the existing analysis model while maintaining the geometric characteristics thereof as they are, when producing the analysis model with utilizing the existing analysis model.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a system view for showing the basic structure portions of an analysis model producing system, according to an embodiment of the present invention;

FIG. 2 is a system view for showing the additional structure portions of the analysis model producing system, according to the embodiment of the present invention;

FIG. 3 is a flowchart for showing the processes of producing an analysis model;

FIG. 4 is a view for showing an example of an operation screen, which is displayed when conducting an input process of an existing analysis model;

FIGS. 5(a) and 5(b) are views for showing an example of the existing analysis model;

FIG. 6 is a view for showing an example of an operation screen for conducting each of processes, such as, a geometrically restricted editing, a geometric value calculation, and a deforming of the existing analysis model;

FIGS. 7(a) to 7(c) are views for showing an example of a characteristic configuration acknowledging operation screen;

FIGS. 8(a) to 8(h) are views for showing a process within a mesh set calculating portion 109, in form of an image thereof;

FIGS. 9(a) and 9(b) are views for showing an example of an operation screen, which is displayed when processing by means of a geometric characteristic modify portion, showing an example of an emphasizing display by means of a geometric characteristic emphasizing displaying portion in form of an image thereof;

FIGS. 10(a) and 10(b) are views for showing an example of an operation screen, which is displayed when processing by means of a characteristic configuration modify portion, showing an example of an emphasizing display by means of a characteristic configuration emphasizing displaying portion in form of an image thereof;

FIG. 11(a) to 11(c) are views for showing an example of a processing step for producing a new analysis model from the existing analysis model, in one example, in form of an image thereof;

FIG. 12(a) to 12(c) are views for showing an example of a processing step for producing anew analysis model from the existing analysis model, in other example, in form of an image thereof; and

FIG. 13(a) to 13(c) are also views for showing an example of a processing step for producing a new analysis model from the existing analysis model, in further other example, in form of an image thereof.

### DETAILED DESCRIPTION OF THE INVENTION

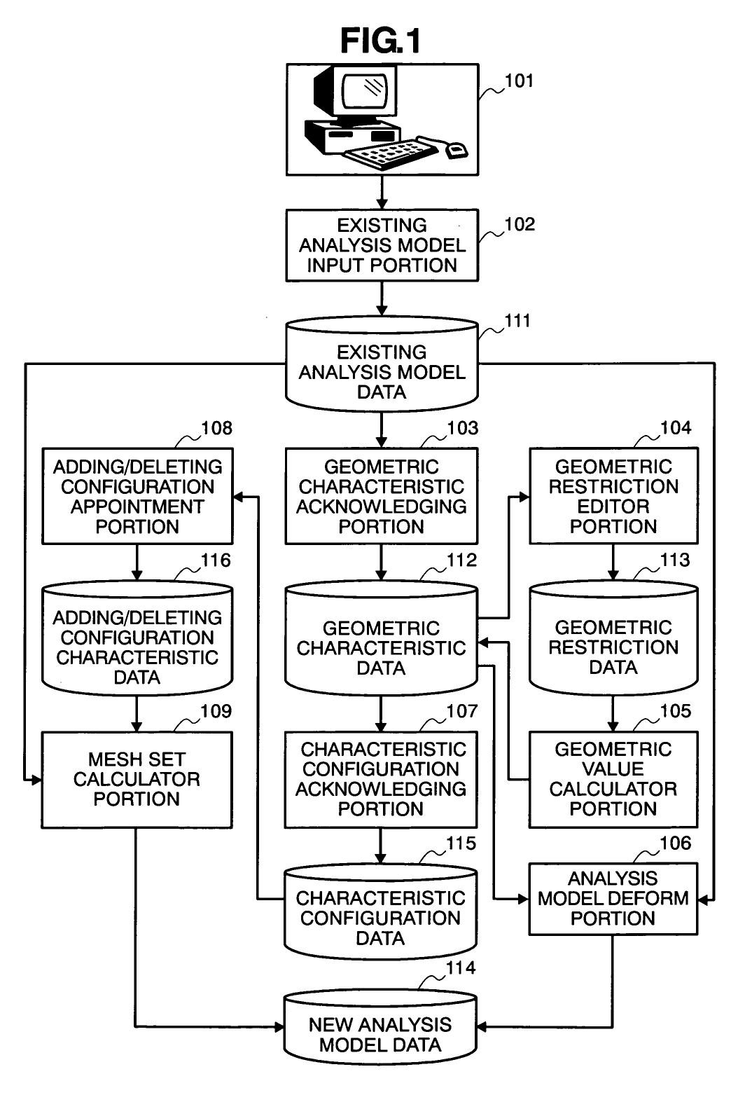

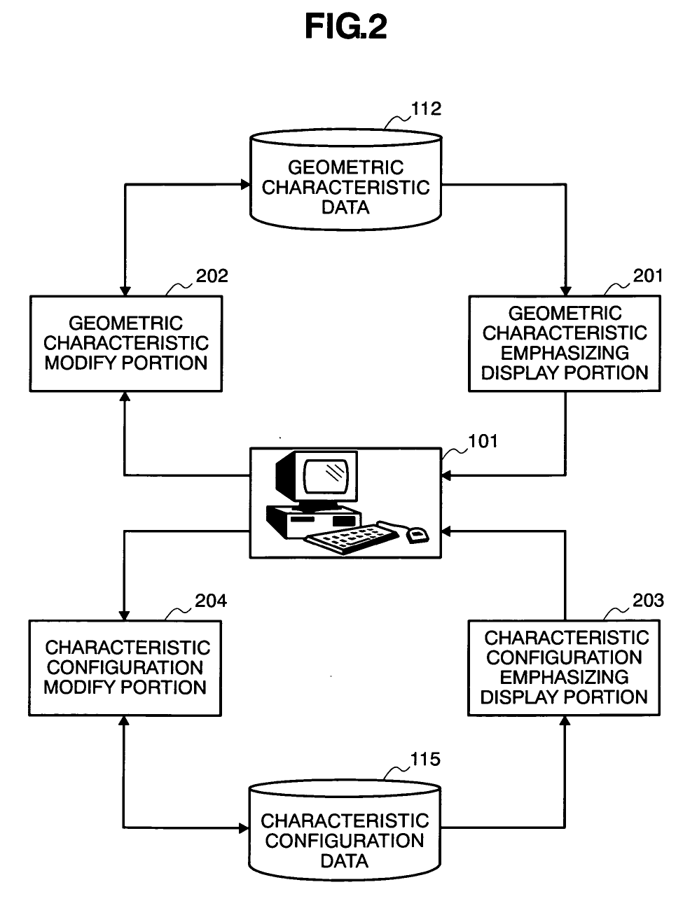

Hereinafter, embodiments according to the present invention will be fully explained by referring to the attached drawings. FIG. 1 shows the configuration of an analysis model producing system, according to one example of the present invention. The present system is constructed with a hardware system, in which a data processing apparatus, such as, a computer, etc., is applied, and a software system (i.e., computer programs, which is installed into the hardware system. The hardware system, including therein a data processing apparatus and a data storage device, etc., though not shown in the figure, includes an input/output device 101, which is provided for a system user to make input and/or display data thereof, and this input/output device 101 comprises a keyboard, a pointing device and a display, etc., for example. On the other hand, an analysis model producing means (i.e., an analysis model producing means through deformation of an existing analysis model), which is constructed in the form of computer programs, comprises an existing analysis model input portion 102, a geometric characteristic acknowledge portion 103, a geometric restriction editor portion 104, a geometric value calculator portion 105, an analysis model deform portion 106, a characteristic configuration acknowledge portion 107, an adding/deleting configuration appointment portion 108 and a mesh set calculator portion 109, and as is shown in FIG. 2, it further comprises a geometric characteristic emphasizing display portion 201, a geometric characteristic modify portion 202, a characteristic configuration emphasizing display portion 203, and a characteristic configuration modify portion 204. Brief explanation will be given about the processes executed in each of those functional portions, below.

The existing analysis model input portion 102 inputs the existing analysis model to be used as the basis of an analysis model, which will be produced newly, and registers it to be an existing analysis model data 111.

The geometric characteristic acknowledge portion 103 acknowledges an element surface (i.e., an outer surface of the element), which builds up the geometric characteristic thereof, such as, a plane (flat surface), a cylindrical surface, a conical surface, a spherical surface, a torus surface, a free surface, etc., for example, on the outer surface of the existing analysis model data 111. Thus, it divides the outer surfaces of the existing analysis model data 111 into areas or regions upon basis of such criteria of the geometric characteristics of the respective surfaces thereof as was mentioned above, and acknowledges the areas to be the outer surface elements, each having such the geometric characteristic, respectively. In addition to acknowledging the outer surface elements, it also acknowledges a geometric sort or kind of a line (for example, a straight line, a circular arc, a free curve, etc.), which is defined by a set of edges of the elements making up a boundary of the geometric characteristic on the outer surface of the elements, and further it acknowledges joints or panel points, at which those lines of geometric characteristics intersect with each other, to be as geometric points. And, it registers the geometric characteristics, such as, the surfaces, the lines, and the points, to be geometric characteristic data 112.

The geometric restriction editor portion 104 sets up geometric restricting relationship for the geometric characteristic data 112, and register the setup to be geometric restriction data 113. It also enables to change the geometric relationship of the geometric restriction data 113.

The geometric value calculator portion 105 calculates geometric value of the geometric characteristic data 112 upon basis of the geometric restriction data 113, the geometric relationship of which is changed, and registers it into the geometric characteristic data 112.

The analysis model deform portion 106 produces new analysis model data 114, through moving the respective panel points on the existing analysis model data 111 in such a manner that they coincide with the geometric characteristic data 112 of the geometric values, which are calculated within the geometric value calculator portion 105.

The characteristic configuration acknowledge portion 107 acknowledges characteristic configuration portions building up lo a characteristic configuration, such as, a rib, a hole, a fillet, etc., and registers them to be characteristic configuration data 115.

The adding/deleting configuration appointment portion 108 inputs a portion to be deleted from or a configuration to be added onto the characteristic configuration data 115, and registers it to be as adding/deleting characteristic configuration data 116.

The mesh set calculator portion 109 produces the new analysis model data 114 by conducting a set calculation upon the adding/deleting characteristic configuration data 116 and the existing analysis model data 111.

The geometric characteristic emphasizing display portion 201 displays the geometric characteristic data 112 in the existing analysis model data 111, emphasizing with a geometric characteristic unit or a geometric characteristic kind unit thereof, in case when displaying the existing analysis model data 111 on a display of the input/output device 101.

The geometric characteristic modify portion 202 revises or modifies the area of the outer surface element and the geometric characteristic kind within the geometric characteristic data 112, in a dialogue or interactive manner.

The characteristic configuration emphasizing display portion 203 displays the characteristic configuration data 115 in that existing analysis model data 111, emphasizing with the geometric characteristic unit or the geometric characteristic kind unit thereof, in case when displaying the existing analysis model data 111 on a display of the input/output device 101.

The characteristic configuration modify portion 204 revises or modifies the characteristic configuration portion and the characteristic configuration kind in the characteristic configuration data 115, in the interactive manner.

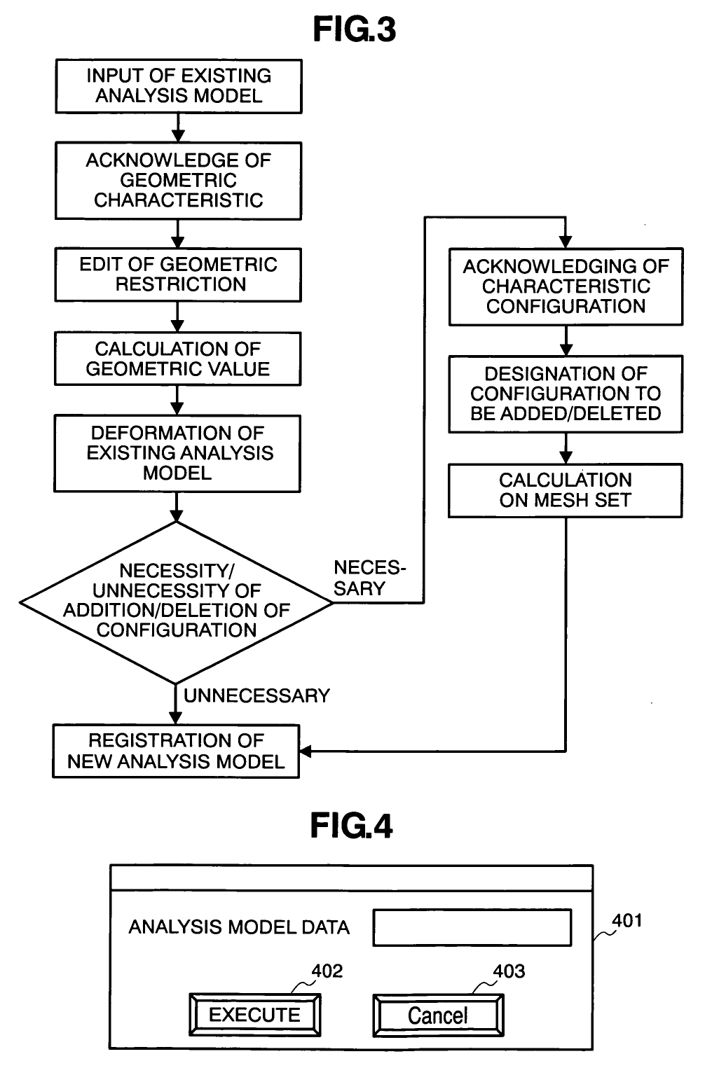

FIG. 3 shows a flow of the analysis model producing process by means of the analysis model producing means, which has such the various functional portions mentioned above. First, an existing analysis model inputting process 301 is conducted by means of the existing analysis model input portion 102. Then, the followings are conducted, sequentially; i.e. an acknowledging process 302 of the geometric characteristics by means of the geometric characteristic acknowledge portion 103, an editing process 303 of the geometric restrictions by means of the geometric restriction editor portion 104, a calculating process 304 of the geometric values by means of the geometric value calculator portion 105, and a deforming process 305 of the existing analysis model by means of the analysis model deform portion 106. When the process reaches up to the deforming process 305 of the existing analysis model, then at that time point, an adding/deleting necessity/unnecessary determining process 306 is conducted, asking a user of necessity/unnecessary of adding/deleting of the characteristic configuration. If it is determined to be unnecessary, the process advances to a registering process 307 of the new analysis model, and wherein the analysis model data, being obtained within the deforming process 305 of the existing analysis model, is registered to be as the new analysis model data 114. On the other hand, if addition/deletion is determined to be necessary of the characteristic configuration, in the process 306, the process moves into an acknowledging process 308 of the characteristic configuration by means of the characteristic configuration acknowledge portion 107, and then, sequentially conducting an appointment process 308 of configuration to be added/deleted on the characteristic configuration by means of the adding/deleting configuration appointment portion 108, and a calculating process 310 of the set of meshes by means of the mesh set calculator portion 109, it moves into the registering process 307 of the new analysis model, and wherein the analysis model data obtained within the calculating process 310 of the set of meshes is registered to be as the new analysis model data 114.

Hereinafter, explanation will be made about detailed examples of the processes in the various functional portions mentioned above.

<<Existing Analysis Model Input Portion>>

FIG. 4 shows an example of an operation screen to be displayed when conducting the existing analysis model inputting process by means of the existing analysis model input portion 102. On an existing analysis model inputting process operating screen are provided an existing analysis model data field 401, an executing button 402, and a canceling button 403. On that operating screen, firstly the user inputs a file name of the existing analysis model data into the existing analysis model data field 401 by means of the input/output device 101. Then, when the execute button 402 is pushed down, the file having the file name, which is inputted into the existing analysis model data field 401, is registered to be the existing analysis model data 111. When completing this registration, the process is started within the geometric characteristic acknowledge portion 103. On the other hand, when the canceling button 403 is pushed down after inputting the file name of the existing analysis model data, then the input is cancelled.

<<Geometric Characteristic Acknowledge Portion>>

The geometric characteristic acknowledge portion 103, acknowledging the element surface (i.e., the outer surface of the element), which builds up the geometric characteristic thereof, such as, the plane (the flat surface), the cylindrical surface, the conical surface, the spherical surface, the torus surface, the free surface, etc., for example, on the outer surface of the existing analysis model data 111, also acknowledges the geometric sort or kind of the line (for example, the straight line, the circular arc, the free curve, etc.), which is defined by the set of edges of the elements making up the boundary of the geometric characteristic on the outer surface of the elements, and further it acknowledges the joints or the panel points, at which those lines of geometric characteristics intersect with each other, to be the geometric points, and those geometric characteristics, i.e., the surfaces, the lines and the points, are registered to be the geometric characteristic data 112. The geometric characteristic data 112 includes a parameter or the geometric value of the outer surface element, and parameters or the geometric values of the kind of the geometric character on that outer surface element and that geometric character, which are acknowledged to be the same geometric characteristic, on the surfaces thereof, also parameters of the geometric kinds and the geometric characteristics of the element edges and the lines acknowledged, on the lines, and further the joints and coordinate values thereof, on the points. As an example of the kinds of geometric characteristics, the followings can be listed up:

Kinds of the geometric characteristics (parameters within the brackets)

Planes (a normal line vector, a position)

a cylindrical surface (an axial vector, a point on an axis, a radius)

a conical surface (an axial vector, an apex, a vertical angle)

a spherical surface (a center, a radius)

a torus surface (a center, an axial vector, a main radius, an auxiliary radius)

a free surface (a control point, etc.)

a straight line (a start point, an end point)

a circular arc (a center, a radius)

a free line (a control point, etc.)

a point (coordinate values)

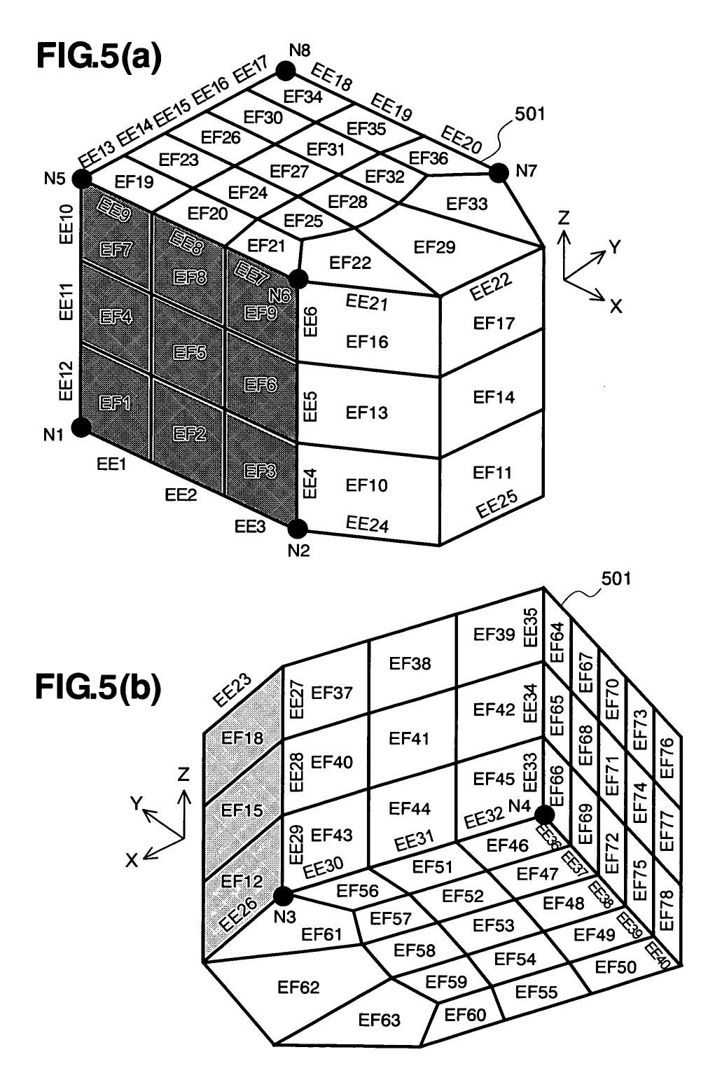

As an example of geometric characteristic acknowledgement, it is made by the followings, in a case of an existing analysis model data 501 shown in FIGS. 5(a) and 5(b). However, FIG. 5(b) is a view of showing the model from the opposite direction thereof, under the condition shown in FIG. 5(a). Also, it is assumed that the point of origin of the existing analysis model data 501 is located at the position “Nl”.

EFs 1-9: planes: normal line (0, −1, 0), position (0)

EFs 19-36: planes: normal line (0, 0, 1), position (10)

EFs 37-45: planes: normal line (0, 1, 0), position (10)

EFs 46-63: planes: normal line (0, 0, −1), position (0)

EFs 64-78: planes: normal line (−1, 0, 0), position (0)

EFs 10-18: cylindrical surfaces: axis (0, 0, 1), point on axis (10, 5, 0), radius (5)

EEs 1-3: straight lines: start point (0, 0, 0), end point (10, 0, 0)

EEs 4-6: straight lines: start point (10, 0, 0), end point (10, 0, 10)

EEs 7-9: straight lines: start point (10, 0, 10), endpoint (0, 0, 10)

EEs 10-12: straight lines: start point (0, 0, 10), endpoint (0,0,0)

EEs 13-17: straight lines: start point (0, 0, 10), end point (0, 10, 10)

EEs 18-20: straight lines: start point (0, 10, 10), end point (10, 10, 10)

EEs 27-29: straight lines: start point (10, 10, 10), end point (10, 10, 0)

EEs 30-32: straight lines: start -point (10, 10, 0), end point (0, 10, 0)

EEs 33-35: straight lines: start point (0, 10, 0), end point (0, 10, 10)

EEs 36-40: straight lines: start point (0, 10, 0), endpoint (0, 0, 0)

EEs 21-23: circular arcs: center (10, 5, 10), radius (5)

EEs 24-26: circular arcs: center (10, 5, 0), radius (5)

N1: point: coordinate values (0, 0, 0)

N2: point: coordinate values (10, 0, 0)

N3: point: coordinate values (10, 10, 0)

N4: point: coordinate values (0, 10, 0)

N5: point: coordinate values (0, 0, 10)

N6: point: coordinate values (10, 0, 10)

N7: point: coordinate values (10, 10, 10)

N8: point: coordinate values (0, 10, 10)

<<Geometric Restriction Editor Portion>>

The geometric restriction editor portion 104 sets up the geometric restriction relationship on the geometric characteristic data 112, and registers it to be the geometric restriction data 113, and it further changes the geometric relationship of the geometric restriction data 113. Into the geometric restriction data 113 are registered the geometric characteristics, the kinds of the geometric restriction and the geometric restriction parameters, upon which the geometric restrictions may be targeted. As an example of such the geometric restrictions, the followings are listed up:

Kinds of Geometric Restrictions

a distance size: a distance between two (2) surfaces (or lines)

an angle size: an angle between two (2) surfaces (or lines)

a radius size: a radius or a diameter of a cylindrical surface, a spherical surface, a torus surface, or a circular arc

parallel: two (2) surfaces (or lines) are parallel with

vertical: two (2) surfaces (or lines) are vertical with

equal: two (2) surfaces (or lines) are equal with

vertical: two (2) surfaces (or lines) are vertical with

tangential: two (2) surfaces (or lines) are continuous on the tangential lines and neighboring with

fixed: surface (or line) is fixed

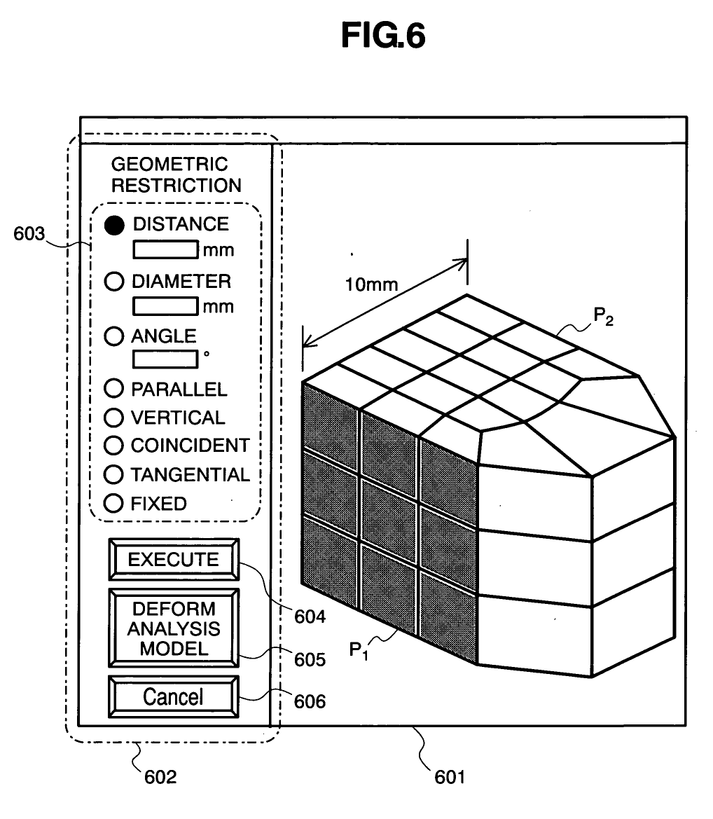

The editing process of geometric restriction by means of the geometric restriction editor portion 104, i.e., setting up and changing of the geometric restriction are the processes of defining a region of deformation when deforming the existing analysis model for the purpose of producing the new analysis model through the geometric restriction, and it will be executed as follows, as an example thereof. An example shown in FIG. 6 is an operation screen for conducting each of the processes, such as, the geometric restriction editing, the geometric value calculation, and the existing analysis model deforming, for example. On this analysis model producing operation screen are included an analysis model displaying area 601 for displaying the analysis model of a target of process therein, and an inputting column 602 of the geometric restrictions, etc., which will be displayed when an input operation is needed, such as, the geometric restriction, etc. Within the inputting column 602 are provided a geometric restriction designation filed 603, an execute button 604, an analysis model deformation button 605 and a cancel button 606.

Firstly, the user selects a target configuration (i.e., the outer surface element, etc.) to be applied the geometric restriction thereon, with using the input/output device 101. Then, the inputting column 602 is displayed, and therefore the user inputs the geometric restriction within the geometric restriction designation filed 603, such as, inputting “10 mm” into “distance between two (2) surfaces P1 and P2”, for example. Then, when pushing down the execute button 604, the geometric restriction is displayed in the analysis model displaying area 601. In case when trying to change the geometric restriction displayed, further, then the user selects the geometric restriction to be the target of change from the analysis model displaying area 601, first. Then, upon receipt of the display of the inputting column 602 of the geometric restriction, the user inputs the geometric restriction after changing. Next, when the execute button 604 is pushed down, then the geometric restriction display of the analysis model displaying area 601 is renewed. After completing the geometric restriction in this manner, the user pushes down the analysis model deformation button 605. Upon receipt of this, processes are executed, sequentially, by means of the geometric value calculator portion 105 and the characteristic configuration acknowledge portion 107, and renewal is made on the display of the analysis model within the analysis model displaying area 601, depending upon those processes.

<<Geometric Value Calculator Portion>>

The geometric value calculator portion 105 calculates geometric values of the geometric characteristic data 112 upon basis of the geometric restriction data 113, and registers them into the geometric characteristic data 112. The geometric value calculation process includes the following processing steps, as an example thereof.

Process a: Comparison is made between the geometric restriction data 113 and the geometric characteristic data 112, and then the target configuration of the geometric restriction, which does not satisfies the geometric restriction, is set up to be a moving candidate configuration (i.e., a target configuration of geometric calculation).

Process b: Within the moving candidate configuration, extraction is made upon the configuration, on which a fixing restriction is set up, and this configuration is made to be a standard configuration.

Process c: In case where no standard configuration exists, a reference surface is produced in the middle of a distance size restriction, and then the fixing restriction is made on this reference surface. Further, as the distance size restriction from the reference surface onto two (2) surfaces to be the target of the distance size restriction, a half value (½) of the distance size restriction is set up.

Process d: In case where no such the standard configuration, an arbitrary one (1) of the moving candidate configurations is selected to be the standard configuration.

Process e: With the geometric restriction data, extraction is made on the moving candidate configuration, which has a relationship with the standard configuration, and the geometric value of the moving candidate configuration is calculated out upon the basis of the geometric restriction data. Further, a provisional fixing restriction is set up upon the configuration, which is moved.

Process f: The above processes a to e are repeated until when no movable configuration is remained.

Process g: The fixing restriction is removed from the configuration, on which the fixing restriction is provisionally set up.

Process h: The above processes a to g are repeated until when satisfying all of the geometric restrictions.

<<Analysis Model Deform Portion>>

The analysis model deform portion 106 moves each of the joints of the existing analysis model data 111, so that they are coincident with the geometric characteristic data 112, and thereby producing the new analysis model data 114. Such the analysis model deforming process by means of the analysis model deform portion 106 includes the following processing steps, as an example thereof.

Process a: Regarding the geometric characteristic data 112 and the existing analysis model data 111, comparison is made between the geometric characteristic data of the geometric point and the joint relating to that geometric point, and if they are shifted from each other, then the joint is moved to the geometric point.

Process b: Within the geometric characteristic data 112 and the existing analysis model data 111, comparison is made between the geometric characteristic data of the geometric line and the joint of an element edged relating to that geometric line, and if they are shifted from each other, then the following process c will be conducted.

Process c: Coordinate values are obtained of the joint, after making such the movement thereon that a difference comes to be the minimum between a vector directing from a start or end point of the element edge group relating to the geometric line mentioned above, to the joint of the target of movement, and a vector directing from a start or end point of the target geometric line to the joint after movement, and then the joint of the movement target is moved to the position of the coordinate values of the joint after movement.

Process d: Regarding the geometric characteristic data 112 and the existing analysis model data 111, comparison is made between the geometric characteristic data of the geometric surface and the joint of the outer surface element relating to that geometric surface, and if they are shifted from each other, then the following process e will be done.

Process e: Coordinate values are obtained of the joint, after making such the movement thereon that a difference comes to be the minimum between a vector directing from a boundary element edge of the outer surface element relating to the geometric surface mentioned above to the joint of the target of movement and a vector directing from a boundary line on the target geometric surface to the joint after movement, and then the join of the target of movement to the position of that coordinate values of the joint after movement.

<<Characteristic Configuration Acknowledge Portion>>

The characteristic configuration acknowledge portion 107 acknowledges the characteristic configuration portion, which builds up the characteristic configuration, such as, a rib, a hole, a fillet, etc., from the geometric characteristic data 112, and registers it to be the characteristic configuration data 115. This characteristic configuration data 115 is made from a geometric characteristic group, which is acknowledged to be a same characteristic configuration, and also a sort or kind and a parameter of that characteristic configuration. As the kind of the characteristic configuration, the following can be listed.

Kinds of Characteristic Configuration (parameters in the brackets)

rib: (rib thickness)

hole: (hole diameter)

fillet: (fillet radius)

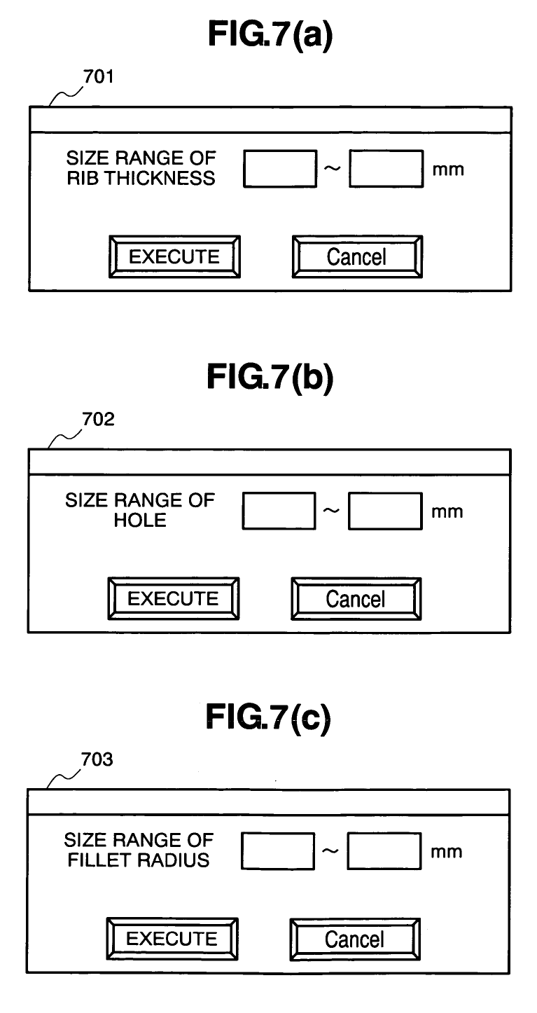

Acknowledgement can be made as follows, through such a characteristic configuration acknowledging and operation screen, as shown in FIGS. 7(a) to 7(c), which the characteristic configuration acknowledge portion 107 displays, as an example.

Acknowledgement of the rib: The user makes input about a range of sizes of the rib to be acknowledged (i.e., size ranges as a definition of the rib) through the screen 701 shown in FIG. 7(a).

Upon receipt of this, first of all, the characteristic configuration acknowledge portion 107 makes search upon two (2) geometric characteristic surfaces (rib candidate surfaces), each distance of which falls within the size range inputted. Next, extraction is made on a surface neighboring at an interior angle, being equal 1800 or greater than that, about the surfaces neighboring to one of the rib candidate surfaces. Then, in case where this neighboring surface is neighboring to both the two (2) rib candidate surfaces, the characteristic configuration having those two (2) rib candidate surfaces is selected to be the rib.

Acknowledgement of the hole: The user makes input about a range of diameter size of the hole to be acknowledged, on the screen 702 shown in FIG. 7(b). Upon receipt of this, first of all, the characteristic configuration acknowledge portion 107 makes search on a closed loop, about the geometric characteristic data, and at the same time, it obtains a circular arc including that closed loop; then, it determines the closed loop, of which the diameter of the circular arc falls within the size range inputted, to be a hole candidate loop. Next, on the geometric characteristic data, the surfaces are expanded into neighboring directions, sequentially, so that the same surface is not included therein, about a group of surfaces neighboring to one side of the hole candidate loop and another group of surfaces neighboring to the other side thereof, respectively. This expansion process is conducted until when no expansion can be made on either one of the surface groups. When completing such expansion process, a total is obtained about the areas of the constituent surfaces, on both surface groups, respectively. Then, the hole is acknowledged to be a group of surfaces constructing the hole, on the side being small in the total area.

Acknowledgement of the fillet: The user makes input about a range of radius size of the fillet to be acknowledged, on the screen 703 shown in FIG. 7(c). Upon receipt of this, the characteristic configuration acknowledge portion 107 acknowledges that to be a fillet surface of the fillet, in case when the radius of the cylindrical surface, the spherical surface, the torus surface, and the free surface, etc., is equal or less than a designated value on the geometric characteristic data and further an angle of the normal line with respect to the neighboring surface is near to zero (0); i.e., the tangential line is continuous.

<<Adding/Deleting Configuration Appointment Portion>>

The adding/deleting configuration appointment portion 108 inputs a portion to be deleted or a configuration to be added onto be the characteristic configuration, with respect to the characteristic configuration data 115, and registers it/them to be as the adding/deleting characteristic configuration data 116 therein. The processes by means of such the adding/deleting configuration appointment portion 108 are conducted as follows, as an example thereof. In case of deletion, first of all, the user makes selection on the characteristic configuration to be a target of deletion by means of the input/output device 101. With this, the adding/deleting characteristic configuration data 116 is outputted, and upon receipt of this, the mesh set calculator portion 109 conducts mesh set calculation. On the other hand, in case of addition, the user produces a configuration to be added with using the input/output device 101. For example, a sketch is drawn by an outline of the configuration to be added, and it is pushed out; thereby to produce the configuration. With doing this, the adding/deleting characteristic configuration data 116 is outputted, and upon receipt of this, the mesh set calculator portion 109 conducts mesh set calculation.

<<Mesh Set Calculator Portion>>

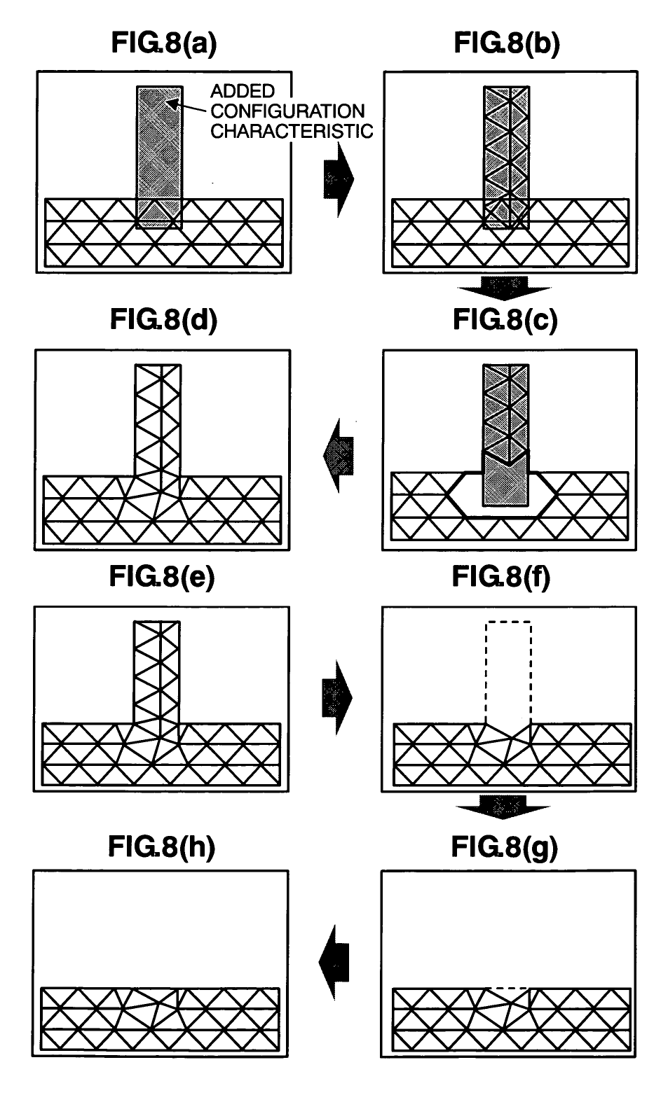

The mesh set calculator portion 109 conducts the set calculations of the adding/deleting characteristic configuration data 116 and the existing analysis model data 111, and thereby producing the new analysis model data 114. An example of the processes by means of the mesh set calculator portion 109 will be shown in FIGS. 8(a) to 8(g), in the form of images thereof. In case of addition of the data registered into the adding/deleting characteristic configuration data 116, first of all, the characteristic configuration data, which is registered to be as the addition target is assembled into the existing analysis model data 111 (FIG. 8(a)). Next, an analysis mesh is produced for this characteristic configuration to be added (FIG. 8(b)). Next, deletion is made on the mesh of an interfering portion between that analysis mesh and the existing analysis model data (FIG. 8(c)). Then, a mesh is produced, newly, for an area to be deleted, thereby obtaining the new analysis model data 114 (FIG. 8(d)). Further, in case if the target to be added is a hole, deletion is made on the analysis mesh, which is produced at first, and this mesh data is used to be the new analysis model data. On the other hand, in case where the data registered into the adding/deleting characteristic configuration data 116 is that to be deleted; and if the target to be deleted is any one, but other than the hole, first of all, designation is made on the characteristic configuration of the target of deletion (FIG. 8(e)). Next, deletion is made on the analysis mesh relating to the characteristic configuration that is designated (FIG. 8(f)). Next, a boundary is produced in a direction extending the neighboring surface at a portion where the analysis mesh is deleted (FIG. 8(g)). Then, an analysis mesh is produced for this area, to be as the new analysis model data 114 (FIG. 8(h)).

<<Geometric Characteristic Emphasizing Display Portion and Geometric Characteristic Modify Portion>>

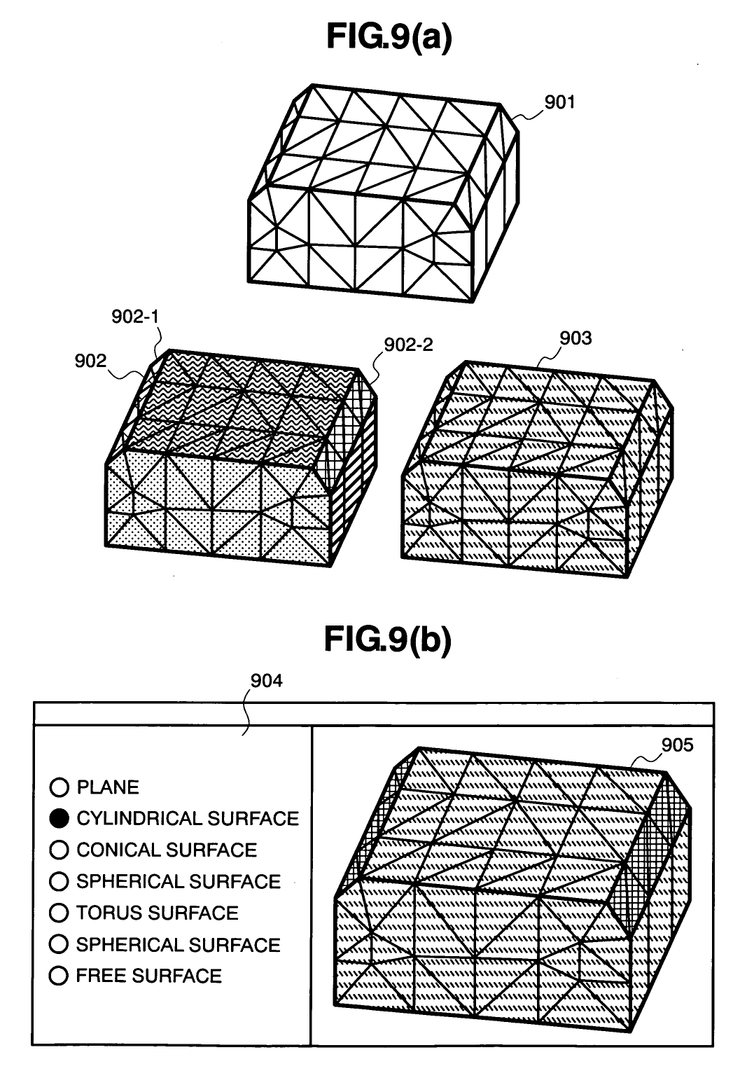

The geometric characteristic emphasizing display portion 201 achieves emphasizing display of the geometric characteristic data 112 within the existing analysis model data 111 by a unit of the geometric characteristic or a unit of kind of the geometric characteristic, when displaying the existing analysis model data 111 on a display of the input/output device 101. The geometric characteristic modify portion 202 modifies or revises the area on the outer surface element and the kind of the geometric characteristic, on the geometric characteristic data 112, in an interactive manner. An example of the emphasizing display by means of such the geometric characteristic emphasizing display portion 201 is shown in FIG. 9(a) in the form of an image thereof. And, an example of the operation screen is shown in FIG. 9(b), which is displayed when conducting the process by means of the geometric characteristic modify portion 202.

Analysis model data 901 in the examples shown in FIGS. 9(a) and 9(b) are acknowledged to be eight (8) pieces of planes, by means of the geometric characteristic acknowledge portion 103. When displaying the acknowledged geometric characteristic data, emphasizing by the unit of geometric characteristic, the data is displayed, like a manner of analysis model data 902, and when displaying them emphasizing by the unit of a kind of geometric characteristic, it is displayed, like a manner of analysis model data 903.

Under the condition of such emphasizing display, the modification or revision is made in the interactive manner, by means of the geometric characteristic modify portion 202. For example, when diagonally modifying the geometric characteristics of the surface 902-1 and the surface 902-2 into cylindrical surfaces, firstly selection is made on the surface 902-1 and the surface 902-2 by means of the input/output device 101, and a cylindrical surface is selected from various kinds of geometric characteristics shown in a geometric characteristic select column 904. With doing this, the surface 902-1 and the surface 902-2 are modified into the cylindrical surfaces, and thereby obtaining modified or revised analysis model data 905.

<<Characteristic Configuration Emphasizing Display Portion>>

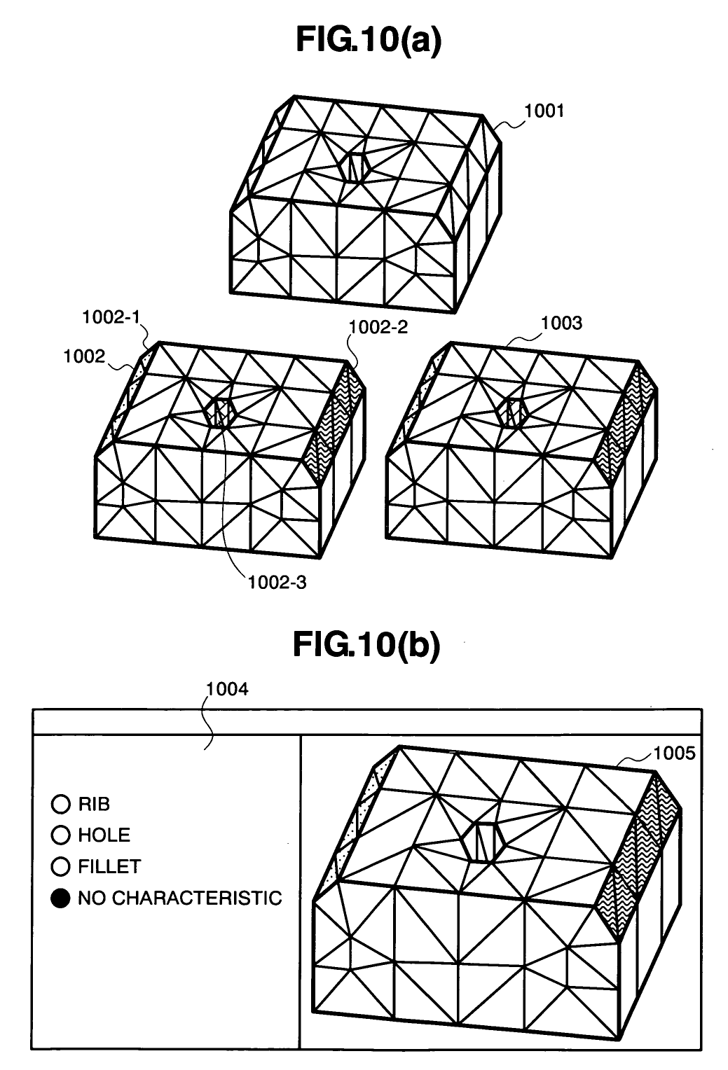

The characteristic configuration emphasizing display portion 203 achieves emphasizing display of the characteristic configuration data 115 within the existing analysis model data 111 by a unit of the characteristic configuration or a unit of kind of the characteristic configuration, when displaying the existing analysis model data 111 on a display of the input/output device 101. The characteristic configuration modify portion 204 modifies or revises the characteristic configuration portion and the kind of characteristic configuration on the geometric characteristic data 112, in the interactive manner. An example of the emphasizing display by means of such the characteristic configuration emphasizing display portion 203 is shown in FIG. 10(a) in the form of an image thereof. And, an example of the operation screen is shown in FIG. 10(b), which is displayed when conducting the process by means of the characteristic configuration modify portion 204.

In the examples of the analysis model data 1001 shown in FIGS. 10(a) and 10(b), one (1) piece of a hole and two (2) pieces of fillets are acknowledged to be the characteristic configurations by means of the analysis model deform portion 106, and they are displayed, like a manner of analysis model data 1002, when displaying those acknowledged characteristic configurations, emphasizing by a unit of the characteristic configuration, or they are displayed, like a manner of analysis model data 1003, when displaying those, emphasizing them by a unit of kind of the characteristic configuration.

Under the condition of such emphasizing display, the modification or revision is made in the interactive manner, by means of the characteristic configuration modify portion 204. For example, in case when modifying the hole 1002-3 among the two (2) pieces of fillets 1002-1 and 1002-2 and the one (1) piece of the hole 1002-3, which are displayed with emphasizing thereof, selection is made on the hole 1002-3 through the input/output device 101, and then “no characteristic” is selected from the various kinds of characteristic configurations, which are displayed within a characteristic configuration select column 1004 on the characteristic configuration modify operation screen. With doing this, analysis model data 1005 can be obtained, wherein the hole 1002-3 is revised to be not a hole.

Hereinafter, explanation will be made on several application examples of the analysis model producing method for producing the new analysis model through deformation of the existing analysis model.

### EXAMPLE 1 OF PRODUCING NEW ANALYSIS MODEL THROUGH DEFORMATION OF EXISTING ANALYSIS MODEL

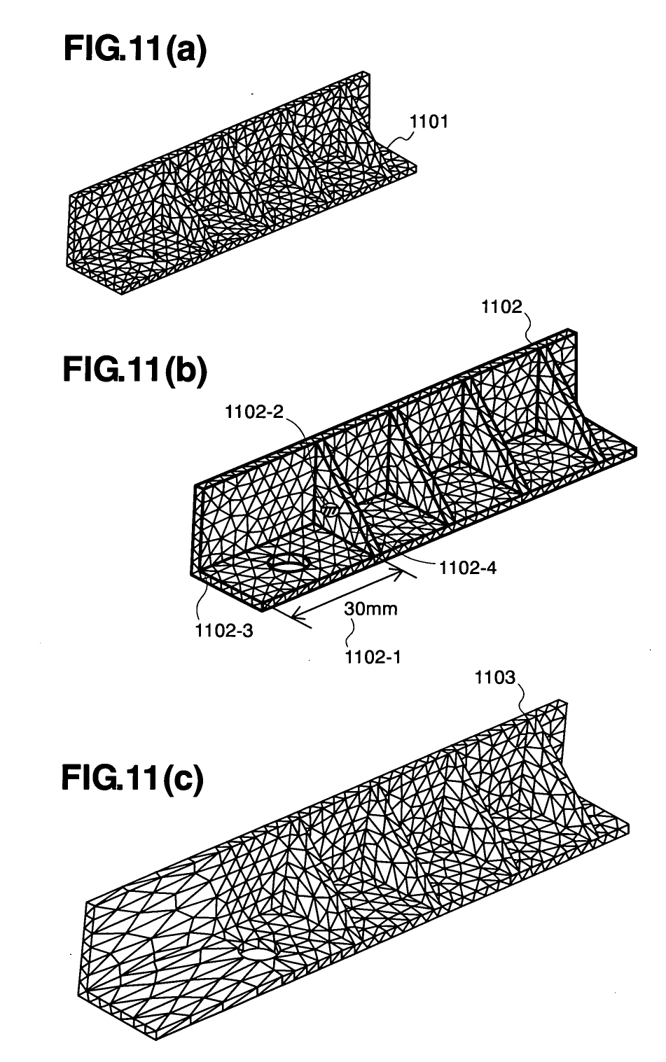

In this example, the new analysis model data is produced from an existing analysis model data 1101 shown in FIG. 11(a), in case when the step advances from the adding/deleting necessity determination process 306 to the registration process 307 in the processing steps shown in FIG. 3. First of all, the user designates the existing analysis model with using an input screen shown in FIG. 4. Next, the geometric characteristics thereof are acknowledged by means of the geometric characteristic acknowledge portion 103, so as to produce the geometric characteristic data. With the existing analysis model data 1101, it is acknowledged like a manner of geometric characteristic data 1102 shown in FIG. 11(b) (i.e., a thick line presents the geometric characteristic of the line, and a portion surrounded by the thick line is the geometric characteristic of the surface). Next, geometric restriction is inputted by means of the geometric restriction editor portion 104. In the present example, setup of a size of distance is made at one (1) place (1102-1), and the fixing restriction at one (1) place (1102-2). Next, geometric values of the respective geometric characteristics are calculated by means of the geometric value calculator portion 105. In the present example, since the size 1102-1 is not satisfied with, then the geometric characteristic 1102-3 comes to be the moving candidate configuration. And, the standard configuration is the geometric characteristic 1102-4. After completing the calculation upon the geometric characteristics by means of the geometric value calculator portion 105, finally the joints of the existing analysis model are moved by means of the analysis model deform portion 106, so that they are coincident with the geometric characteristic data (i.e., the geometric characteristic data, on which the geometric restrictions are set up by means of the geometric restriction editor portion 104). With doing so, it is possible to obtain such new analysis model data 1003 as shown in FIG. 11(b). With the example of producing such the analysis model, deformation can be made on, for example, a truly circular hole, while maintaining the geometric characteristic, such as, being that truly circular hole, for example. Thus, when producing an analysis model at desire with using the existing analysis model therein, it is possible to modify or deform the existing analysis model while keeping the geometric characteristics thereof, and thereby obtaining the new analysis model.

### EXAMPLE 2 OF PRODUCING NEW ANALYSIS MODEL THROUGH DEFORMATION OF EXISTING ANALYSIS MODEL

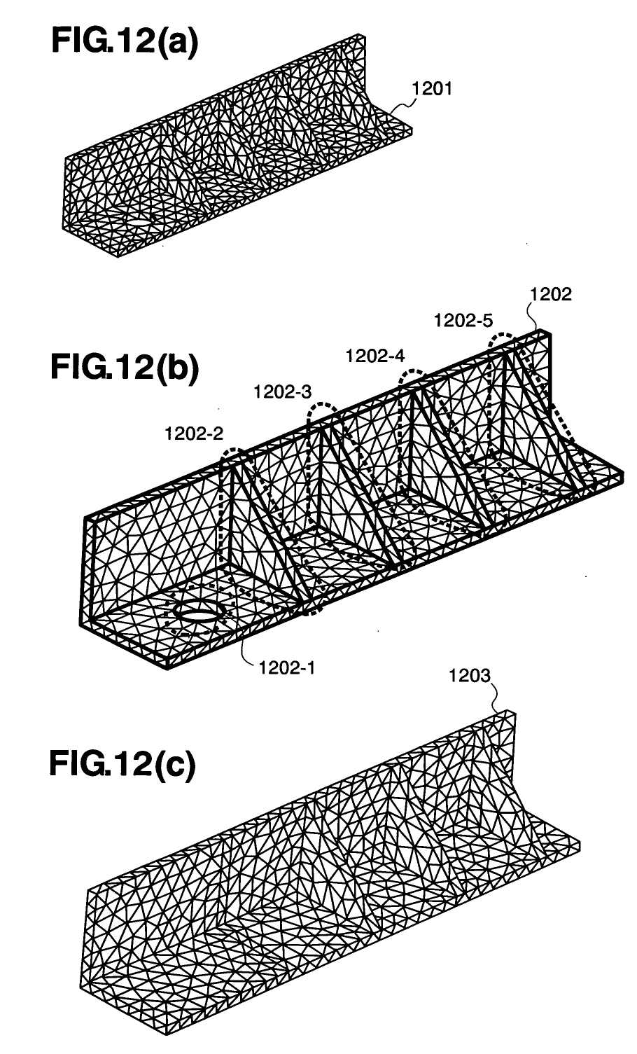

In this example, the new analysis model data is produced from an existing analysis model data 1201 (being same to the existing analysis model data 1101 shown in FIG. 11(a)) shown in FIG. 12(a), in case when the step advances from the adding/deleting necessity determination process 306 to the acknowledging process 308 of characteristic configuration in the processing steps shown in FIG. 3. First of all, the user designates the existing analysis model with using an input screen shown in FIG. 4. Next, the geometric characteristics thereof are acknowledged by means of the geometric characteristic acknowledge portion 103, so as to produce the geometric characteristic data. Next, the characteristic configuration is acknowledged by means of the characteristic configuration acknowledge portion 107, so as to produce the characteristic configuration data. With the existing analysis model data 1201, the hole 1201-1 and the ribs 1202-2 to 1202-5 are acknowledged, like the manner of the characteristic configuration data 1202 shown in FIG. 12(b). Next, the hole 1201-1 and the rib 1202-2 are designated to be the characteristic configurations of the target to be deleted by means of the adding/deleting configuration appointment portion 108. Next, those characteristic configurations are deleted by means of the mesh set calculator portion 109. With doing so, it is possible to obtain such new analysis model data 1203 as shown in FIG. 12(c). With the example of producing such the analysis model, when producing an analysis model at desire with using the existing analysis model therein, it is also possible to make great deformation, easily, upon the existing analysis model, i.e., deletion of the characteristic configurations, such as, the rib and/or the hole, etc., for example.

### EXAMPLE 3 OF PRODUCING NEW ANALYSIS MODEL THROUGH DEFORMATION OF EXISTING ANALYSIS MODEL

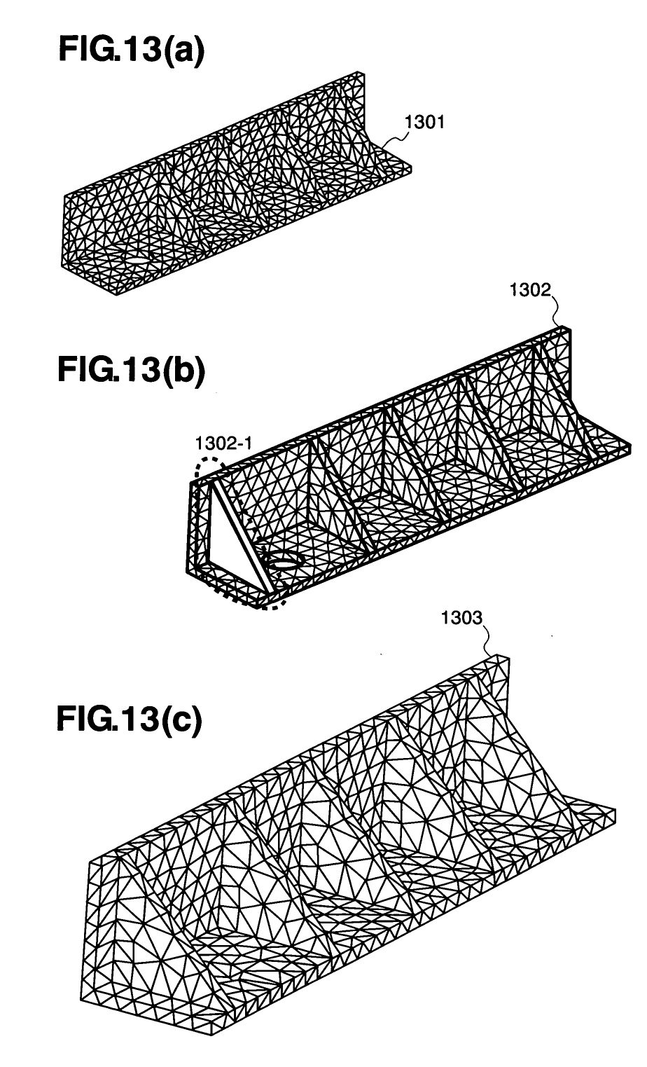

In this example, the new analysis model data is produced from an existing analysis model data 1301 (being same to the existing analysis model data 1101 shown in FIG. 11(a)) shown in FIG. 13(a), in case when the step advances from the adding/deleting necessity determination process 306 to the acknowledging process 308 of characteristic configuration in the processing steps shown in FIG. 3. First of all, the user designates the existing analysis model with using an input screen shown in FIG. 4. Next, the geometric characteristics thereof are acknowledged by means of the geometric characteristic acknowledge portion 103, so as to produce the geometric characteristic data. Next, the characteristic configuration is acknowledged by means of the characteristic configuration acknowledge portion 107, so as to produce the characteristic configuration data. Next, designation is made on a characteristic configuration 1302-1 to be a target configuration to be added, as shown in FIG. 13(b), by means of the adding/deleting configuration appointment portion 108. Next, this characteristic configuration is added by means of the mesh set calculator portion 109. With doing so, it is possible to obtain such new analysis model data 1303 as shown in FIG. 13(c). With the example of producing such the analysis model, when producing an analysis model at desire with using the existing analysis model therein, it is also possible to make great deformation, easily, upon the existing analysis model, i.e., addition of the characteristic configurations, such as, the rib and/or the hole, etc., for example.

### INDUSTRIAL APPLICABILITY OF THE INVENTION

With the present invention, it is possible to obtain the analysis model at the desire through deforming the existing analysis model while maintaining the geometric characteristics as they are, when producing the analysis model with using the existing analysis model therein, and further it also enables to make great deformation on the existing analysis model, easily, such as, addition and/or deletion of the characteristic configurations; therefore, it can be applied widely, in particular, in a field of CAE, etc.

the characteristic configuration is acknowledged by means of the characteristic configuration acknowledge portion 107, so as to produce the characteristic configuration data.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. In an analysis model producing system having an analysis model producing means therein, for newly producing an analysis model with using an existing analysis model therein, said analysis model producing means comprising:
a geometric characteristic acknowledging portion for acknowledging a geometric characteristic from an outer surface element of the existing analysis model;
a geometric restriction editor portion for setting a geometric restriction upon the geometric characteristic acknowledged within said geometric characteristic acknowledging portion;
a geometric value calculator portion for calculating a geometric value of the geometric characteristic satisfying the geometric restriction set up within said geometric restriction editor portion; and
an analysis model deforming portion for moving respective joints on said existing analysis model, so that they are coincident with the geometric characteristic, by the geometric value obtained within said geometric value calculator portion.

2. The analysis model producing system, as described in the claim 1, wherein said analysis model producing means further comprises:
a characteristic configuration acknowledging portion for acknowledging a characteristic configuration from the geometric characteristic acknowledged by said geometric characteristic acknowledging portion,
an adding/deleting configuration appointment portion for designating the characteristic configuration to be deleted or to be added newly, with respect to the characteristic configuration acknowledged by said characteristic configuration acknowledging portion, and
a mesh set calculator portion for conducting mesh calculation on the characteristic configuration being a target of deletion or addition, which is designated within said adding/deleting configuration appointment portion, and said existing analysis model.

3. The analysis model producing system, as described in the claim 1, wherein said analysis model producing means further comprises:
a geometric characteristic emphasizing display portion for displaying the geometric characteristic within the existing analysis model, emphasizing by a unit of the geometric characteristic and/or a unit of kind of the geometric characteristic, when displaying said existing analysis model, and
a geometric characteristic modify portion for revising an area and a kind of said geometric characteristic, in an interactive manner.

4. The analysis model producing system, as described in the claim 2, wherein said analysis model producing means further comprises:
a geometric characteristic emphasizing display portion for displaying the geometric characteristic within the existing analysis model, emphasizing by a unit of the geometric characteristic and/or a unit of kind of the geometric characteristic, when displaying said existing analysis model, and
a geometric characteristic modify portion for revising an area and a kind of said geometric characteristic, in an interactive manner.

5. The analysis model producing system, as described in the claim 2, wherein said analysis model producing means further comprises:
a characteristic configuration emphasizing display portion for displaying the characteristic configuration within the existing analysis model, emphasizing by a unit of the characteristic configuration and/or a unit of kind of the geometric characteristic configuration, when displaying said existing analysis model, and
a characteristic configuration modify portion for revising said characteristic configuration and a kind thereof, in an interactive manner.

6. The analysis model producing system, as described in the claim 3, wherein said analysis model producing means further comprises:
a characteristic configuration emphasizing display portion for displaying the characteristic configuration within the existing analysis model, emphasizing by a unit of the characteristic configuration and/or a unit of kind of the geometric characteristic configuration, when displaying said existing analysis model, and
a characteristic configuration modify portion for revising said characteristic configuration and a kind thereof, in an interactive manner.

7. The analysis model producing system, as described in the claim 4, wherein said analysis model producing means further comprises:
a characteristic configuration emphasizing display portion for displaying the characteristic configuration within the existing analysis model, emphasizing by a unit of the characteristic configuration and/or a unit of kind of the geometric characteristic configuration, when displaying said existing analysis model, and
a characteristic configuration modify portion for revising said characteristic configuration and a kind thereof, in an interactive manner.

8. In analysis model producing system having an analysis model producing means therein, for newly producing an analysis model with using an existing analysis model therein, comprising:
a geometric characteristic acknowledging portion for acknowledging a geometric characteristic from an outer surface element of the existing analysis model;
a characteristic configuration acknowledging portion for acknowledging a characteristic configuration from the geometric characteristic acknowledged by said geometric characteristic acknowledging portion;
an adding/deleting configuration appointment portion for designating the characteristic configuration to be deleted or to be added newly, with respect to the characteristic configuration acknowledged by said characteristic configuration acknowledging portion; and
a mesh set calculator portion for conducting mesh calculation on the characteristic configuration being a target of deletion or addition, which is designated within said adding/deleting configuration appointment portion, and said existing analysis model.
